(19) United States
(12) Patent Application Publication
(10) Pub. No.: US 2026/0209395 A1
(43) Pub. Date: Jul. 23, 2026

(54) New Hyaluronan Hydrogels Chemically Crosslinked By MMP Inhibitors

(71) Applicants: CONSORZIO INTERUNIVERSITARIO NAZIONALE PER LA SCIENZA E TECNOLOGIA DEI MATERIALI, Firenze (IT); UNIVERSITA' DEGLI STUDI DI FIRENZE, Firenze (IT); UNIVERSITA' DEGLI STUDI DI SIENA, Siena (IT)

(72) Inventors: Agnese MAGNANI, Sovicille (IT); Cristina NATIVI, Firenze (IT); Marco FRAGAI, Sesto Fiorentino (IT); Gemma LEONE, Siena (IT); Marco CONSUMI, Siena (IT); Simone PEPI, Siena (IT); Oscar FRANCESCONI, Arezzo (IT); Stefano ROELENS, Firenze (IT)

(21) Appl. No.: 19/144,010

(22) PCT Filed: Dec. 20, 2023
(86) PCT No.: PCT/EP2023/086882

§ 371 Date: Jun. 27, 2025

(30) Foreign Application Priority Data
Dec. 30, 2022 (IT) 102022000027330

(51) Int. Cl. C08B 37/08; C08J 3/24

(52) U.S. Cl. CPC C08B 37/0072; C08J 3/242

(57) ABSTRACT

The present invention describes a hyaluronan (HA) chemically crosslinked by a di-, quardri-octavalent matrix metallo-proteinases inhibitor (MMPi). These hydrogels can be used for both medical and cosmetic applications.

### FIELD OF THE INVENTION

The present invention relates to the field of chemically crosslinked hyaluronic acid (HA) and both medical and cosmetic use thereof; more specifically it relates to a HA crosslinked by way of matrix metalloproteinases inhibitors (MMPIs) molecules.

### STATE OF THE ART

HA is a linear polysaccharide whose disaccharide repeating unit is composed of D-glucuronic acid (D-GluU A) and N-Acetyl-D-glucosamine (N-Ac-D-GluN) bound together through β (1,4) and β (1,3) glucosidic bonds.

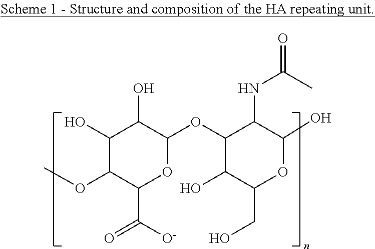

It is a polyanion at physiological pH and belongs to glucosamine glycans family. HA can bind water and self-associate assuming in that way a stiff and viscous behavior. Due to its high hydrophilicity and molecular weight, HA plays mainly structural and hydration roles in human body: it can stabilize and maintain the extracellular matrix (ECM) components in a hydrated state and ensure lubrication and shock-absorbance in joints as well. HA plays several other important roles in cells activity such as the regulation, migration, and adhesion functions. The molecular weight of the polysaccharide plays a very important role in both its function and activity in human body. In fact, depending on MW, HA can play different roles and has good or bad impact in its location. Low molecular weight (LMW) HA (<100 kDa) can induce either inflammatory reactions or immuno-stimulatory and angiogenic effects. On the other hand, high molecular weight (HMW) HA is characterized by anti-inflammatory and anti-angiogenic properties.

HA is present in every compart of vertebrate body and it corresponds to the 0,021% of the human body weight. It is expressed on both the outer surface and inner part of the cells, mostly located in the ECM of all tissues, and in the skin and muscolo-skeletal tissues. The HA concentrations ranges from 0.01-0.1 μg/g in the blood to 0.2 mg/g in the dermis and 1.4-3.6 mg/g in synovial fluid (SF).

Its physio-mechanical properties help to maintain either the hydration or lubrication of tissues, contributing also to the distribution of species through the extracellular environment. HA shows molecular functions that contribute not only to the physiological and structural being of the tissue, but also tune cellular behavior, tissues modelling and inflammation processes during morphogenesis.

Thanks to its ubiquitous presence in the body, HA shows obvious biocompatibility and biodegradability. These aspects, coupled with the possibility of chemical modification of the polysaccharide structure, have contributed to the great attraction towards HA for the design of new biomaterials with important clinical applications. In particular, because of its proper characteristics as natural lubricant and its excellent hydrophilic properties, HA is largely used as viscosupplement in osteoarticular therapies and as dermal filler for local tissue repair due to local degradation of collagen. HA has a high level of elimination and turnover, depending on both its location and molecular weight. These aspects strongly affect the use of HA in biomedical applications: the degradation of the polysaccharide is performed by specific enzymes, the hyaluronidases (HYALs) and also by oxygen free radicals (ROS). The degradation may cause the production of HA fragments with low molecular weight, that can generate inflammatory processes. It is mostly to overcome these limitations that HA is chemically modified or crosslinked. Chemical modification and crosslinking, in fact, are performed with the aim of prolonging its half-life, increasing its resistance to degradation and thus its bioactivity.

Osteoarthrosis (OA) is a degenerative pathology commonly associated with ageing. It is characterized by a slow cartilage degradation process that provokes increasing disability coupled with pain. In OA disease, pharmacological therapies have the only aim of the palliation of pain. Within these treatments there are: analgesics, that include acetaminophen, cyclooxygenase-2 specific inhibitors, non-steroidal anti-inflammatory drugs, tramadol, opioids; topical treatments, that include capsaicin and methyl-salicylate; intra-articular therapies, that include glucocorticoids and hyaluronan. The SF is in cavities in joints and allows the adjacent bones movements. It is constituted by electrolytes, organic molecules with low molecular weight and macromolecules as glycosaminoglycans (GAGs). The GAGs found in SF are chondroitin-4-sulfate (2%) and HA (98%). The SF function of shock absorber and lubricant can be attributed to its mechanical properties, and to the viscoelastic ones. These rheological properties depend on both HA molecular weight and molecular weight distribution, its concentration, and inter- and intra-molecular non-covalent interactions under physiological conditions. HA molecular weight and concentration determine weak interactions between the polysaccharide chains, thus generating a transient network structure which the SF mechanical properties depend on. These characteristics are compromised when pathologies, as OA, cause a decrease in the concentration and/or in the molecular weight of HA. The degradation of SF can be easily monitored measuring its rheological properties. The viscosupplementation is part of the intra-articular therapies and it is a therapeutic technique used in the treatment of the OA where SF, that is the natural lubricant of the joints, is substituted by products that have mechanical properties comparable or even better in comparison with the natural SF. The intra-joint injection of the HA derivatives as viscosupplement has many different effects: this procedure may enhance the regenerative effects of the endogen HA on the joint cartilage, it may also refresh the mechanical properties of the SF and promote the synthesis of other components of the extracellular matrix. It may stimulate the chondrocytes metabolism, prevent the apoptosis, and have analgesic, anabolic and anti-inflammatory effects. In vitro tests have proven that the intra-articular usage of HA may reduce the arachidonic acid release from human synovial fibroblasts, that is absorbed from the synovial leucocytes and converted in inflammatory mediators.

Ageing causes growing tissues damages. Skin dermis, skeletal support and soft tissues are the most susceptible ones. There are two types of ageing: the internal and external one. The first type is the internal ageing of the skin, that generates histological changes of different nature in various skin layers. This type of ageing reduces some skin functions, such as type I and type III collagen production, the turnover rate of the epidermis and the activity of the melanocyte. The second kind of ageing is the external one, that is generated by the exposure to both sun and UV radiations. This kind of ageing is responsible for different histological changes, and it is typified by the elastic tissue damages and the cellularity decrease. The two types of ageing produce an abnormal wound healing, generating a decrease in the content of collagen and in the activity of the melanocyte. To face these problems related to ageing, several treatments have been developed based on the soft-tissue fillers or dermal fillers. A perfect dermal filler must be long-lasting permanence on-site, with minimal or no side-effects or pain for the patient, no pain after injection and an easy administration. Dermal fillers can be classified depending on their time of residence in situ, so they can be divided in temporary, semi-permanent (≥18 months) and permanent. It is possible to classify the dermal fillers also depending on their primary ingredients, such as collagen of various origin, synthetic or animal HA. HA is a FDA approved product as dermal filler. It can be used as viscous solutions called free HA or as modified/crosslinked HA. Using free HA as dermal filler, the treatment has less than one week of efficacy, because of the fast elimination of the injected viscosupplement from the treated site by pathways of degradation and drainage. To enhance its very short half-life, HA is modified producing chemically crosslinked products, that are polymeric networks such as hydrogels. This modification results in an increasing of the residence time reducing the in situ drainage and degradation. Nevertheless, these products show a reduced injectability and can generate pain for the patient during the injection. Main dermal fillers can be distinguished on the base of the origin of HA, its concentration, its 3D shape, its degree and type of the crosslinking, the loading of active species such as anesthetics. Within these characteristics of dermal fillers, one of the most important is HA concentration: higher the concentration longer the activity and better the volumetric effect. On the other hand, a more concentered dermal filler is more viscous, and it is more difficult to be injected. Nowadays, to extend the duration of the treatments, HA based products with a high crosslinking degree and with high molecular weight are preferred.

Among the causes of the just mentioned pathologies, there are inflammatory states that can have different origins, but all of these are characterized by the uncontrolled activation of metallo-enzymes: the matrix metalloproteinases (MMPs). The MMPs are Ca-dependent endopeptidases containing Zn. These enzymes cause the remodeling of the tissue and the ECM degradation, acting on gelatin, elastin, collagens, matrix proteoglycans and glycoproteins. The excretion of these enzymes is performed by different types of connective tissues and pro-inflammatory cells that include lymphocytes, macrophages, neutrophils, endothelial cells, osteoblasts, and fibroblasts. The MMPs are expressed as zymogens that are further processed to generate their active form by other proteolytic enzymes. However, MMPs are generally poorly expressed in normal physiological conditions. The regulation of MMPs is performed by cytokines, growth factors and hormones, the control of these enzymes is performed by endogenous (MMPIs) and tissue MMPs inhibitors (TIMMPs). A variety of pathological diseases raise from MMPs over-expression due to a disproportion between MMPs and TIMMPs activity [14].

At least 26 human MMPs have been found. They are classified according to their specificity in four groups: stromelysins, matrilysins, gelatinases and collagenases.

TABLE 1
Classes of the different MMPs.

| No. | MMP No. | Class | Enzyme |
|---|---|---|---|
| 1 | MMP-1 | Collagenases | Collagenase-1 |
| 2 | MMP-8 | | Neutrophil Collagenase |
| 3 | MMP-13 | | Collagenase-3 |
| 4 | MMP-18 | | Collagenase-4 |
| 5 | MMP-2 | Gelatinases | Gelatinase-A |
| 6 | MMP-9 | | Gelatinases-B |
| 7 | MMP-3 | Stromelysins | Stromelysin-1 |
| 8 | MMP-10 | | Stromelysin-2 |
| 9 | MMP-11 | | Stromelysin-3 |
| 10 | MMP-27 | | Homology to Stromelysin- |
| | | | 2 (51.6%) |
| 11 | MMP-7 | Matrilysins | Matrilysin (PUMP) |
| 12 | MMP-26 | | Matrilysin-2 |
| 13 | MMP-14 | MT-MMPs | MT1-MMP |
| 14 | MMP-15 | | MT2-MMP |
| 15 | MMP-16 | | MT3-MMP |
| 16 | MMP-17 | | MT4-MMP |
| 17 | MMP-24 | | MT5-MMP |
| 18 | MMP-25 | | MT6-MMP |
| 19 | MMP-12 | Other enzymes | Macrophage metalloelastase |
| 20 | MMP-19 | | RASI I |
| 21 | MMP-20 | | Enamelysin |
| 22 | MMP-21 | | MMP identified on |
| | | | chromosome I |
| 23 | MMP-22 | | MMP identified on |
| | | | chromosome I |
| 24 | MMP-23 | | From human ovary cDNA |
| 25 | MMP-28 | | Epilysin |
| 26 | MMP-29 | | Unamed |

An important sub-class of these groups are the membrane-type MMPs (MT-MMPs) that are membrane associated enzymes or contain a membrane liker-, intracellular-, transmembrane-domain. Almost all MMPs are constituted by four different domains: N-terminal pro-domain, the catalytic domain, the hinge region and the C-terminal hemopexin-like domain. The last one seems to be the recognition site for the macromolecular substrate and the interaction site for TIMMPs. The MT-MMPs contain a fifth trans-membrane domain that allows the enzyme to interact with the cell surface. Among all MMPs, MMP-3, MMP-12 and MMP-13 are involved in inflammatory processes at osteoarticular level while MMP-1 is involved in the formation of dermal wrinkles and MMP-9 in ocular diseases. High concentrations of these MMPs are in fact found in subjects with rheumatoid arthritis, osteoarthritis, dermal blemishes, and eye diseases. The inflammatory processes, which are accompanied by a high and uncontrolled concentration of MMPs, cause the uncontrolled degradation of protein substrates such as collagen, but also cause a greater degradation of HA. In the design of synthetic inhibitors of MMPs chemists have taken advantage from specific functional groups known to interact with the Zn (II) active-site ion. Therefore, an effective MMPs inhibitor shall possess the following moieties: Zn-binding groups (the most common are hydroxamate, CONH—O⁻; carboxylate, COO⁻; thiolate, S⁻; phosphinyl, PO₂⁻), functional groups that can provide at least one hydrogen bond interaction with the MMPs backbone, side chains that perform van der Waals interactions with the enzyme sub-sites (R. P. Verma et al., Bioorganic & medicinal chemistry, 2007, 15, 2223-2268).

In the last thirty years, MMPIs with high affinity towards these enzymes have been synthesized and tested, but only few of them passed to clinical trials and with little success. The major limitations of these inhibitors are related to their poor bioavailability caused by their low solubility in water and their scarce selectivity (J. M. Cathcart et al., Frontiers in bioscience (Landmark edition), 2015, 20, 1164-1178). Aim of the present invention is to provide a modified HA having improved stability and permanence “in situ” and anti-inflammatory action.

### Definition and Abbreviations

HA: hyaluronic acid
MMP: matrix metalloproteinase
MMPi: matrix metalloproteinase inhibitor

### SUMMARY OF THE INVENTION

Subject of the present invention is a crosslinked HA derivative of formula (I)

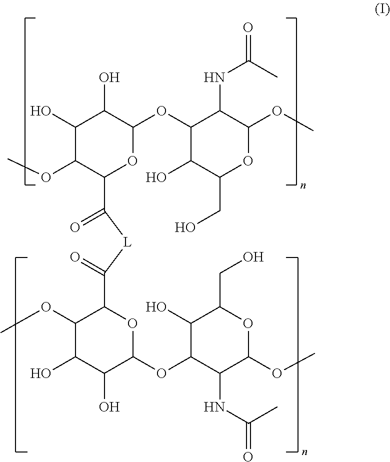

wherein
n is in the range 2.5-25000
L is a bi- quadri- or octa-valent linker of formula (II)

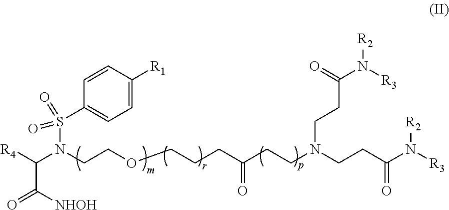

wherein
m is an integer number selected from 0-4;
r is an integer number selected from 1-7;
p is an integer number selected from 1-3;
R₁ is H, OH, OAlk₁₋₄, X, CX₃, Ph, para-C₆H₄—F, OPh, CH₂Ph;
R₂ is H or R₃;
R₃ is selected in the group consisting of CH₂CH₂NH—, CH₂CH₂(CO)NHCH₂CH₂NH—, CH₂CH₂(CO)N(CH₂CH₂NH—)₂;
R₄ is H, CH₂OH, CH₂SH, CH₂CH₂SMe, CH(CH₃)₂, CH(CH₃)OH.

The HA derivative of the invention is a hyaluronic acid chemically cross-linked via an inhibitor of MMPs, that improves HA permanence “in situ” and stability, by inhibiting MMPs pro-inflammatory action.

The new HA derivative, in which the polysaccharide chains are chemically crosslinked through the linker MMPI, shows increased mechanical properties and the characteristic rheological behavior of chemically crosslinked hydrogels. Thanks to these properties this innovative hydrogel can be used in medicine and cosmetic as both viscosupplement and filler.

Furthermore, thanks to the presence of the linker MMPI, the derivative exhibits anti-inflammatory properties, and an enhanced HA resistance to degradation. Indeed, it can inhibit the specific MMPs iper-expressed in pathologies or blemishes formation in which the HA is already used. The crosslinked HA results much more stable state, with respect to the native polysaccharide. The main consequences are a reduced enzymatic degradation and, therefore, a reduced production of the pro-inflammatory LMW HA fragments.

Further subject of the invention is therefore the HA derivative as above described for use as medicament, in the treatment of inflammatory processes involved in osteoarticular diseases.

The HA derivative present invention can be used in aesthetic medicine and cosmetics as treatment for the skin blemishes due to aging.

For an aspect, subject-matter of the present invention is a pharmaceutical or cosmetic formulation, comprising the HA derivative of the invention and at least another pharmaceutical or cosmetic suitable component or active specie/s.

For an aspect subject-matter of the present invention is a process for preparing the HA derivative of formula (I) as above described wherein HA is contacted with a compound of formula (IIa)

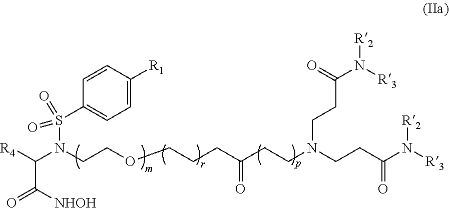

wherein m, r, p R₁ and R₄ are as described above;
R′₂ is H or R′₃;
R′₃ is selected in the group consisting of CH₂CH₂NH₂, CH₂CH₂(CO)NHCH₂CH₂NH₂, CH₂CH₂(CO)N(CH₂CH₂NH₂)₂.

### DETAILED DESCRIPTION OF THE INVENTION

Alk₁₋₄ means an alkyl residue having 1-4 carbon atoms.

X means a halogen.

A product described in the present invention may have a degree of functionalization between 0.1% and 100% of the active site of the repeating unit of HA(HAᵣᵤ).

Preferably m=0, r=2, p=1.

Preferably R1 is OMe.

Preferably R₂ is H and R₃ is CH₂CH₂NH—.

Preferably R₄ is H, CH₂OH.

Preferably R′₂ is H and R′₃ is CH₂CH₂NH₂.

Preferred HA derivative of the present invention has L selected in the group consisting of

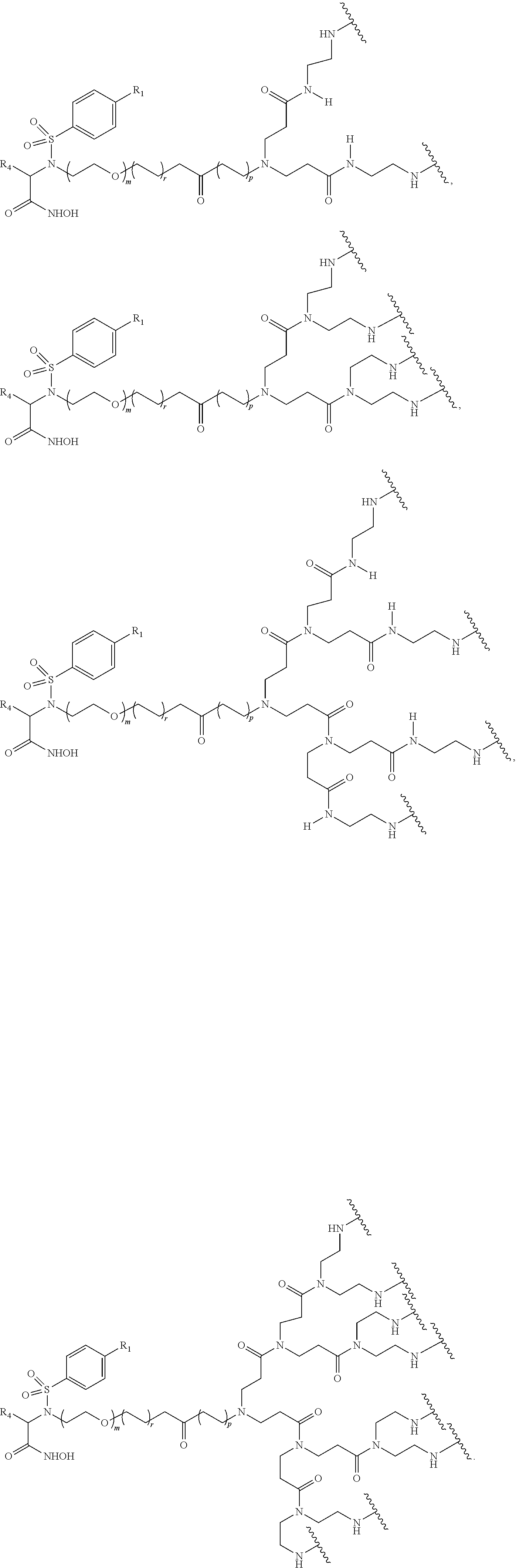

Crosslinking of the HA derivatives of the present invention is by means of amide bonds between the carboxylic function of the HA and the amine functions of the linker L.

More preferred linker according to the invention is MMPi-bis of formula (II-bis):

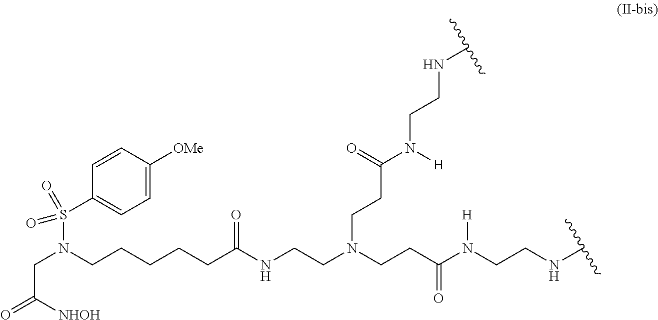

Preferably according to the invention, the process is carried out in homogeneous phase.

According to the present invention it is preferred to use a HA with a molecular weight from 0.1 MDa to 3 MDa. The process according to the invention preferably comprises contacting the HAᵣᵤ and a compound of formula (IIa) in 100:1-1:1, preferably 3:1 molar ratio.

The process according to the invention preferably includes the presence of an initiator and/or a catalyst. Preferably the initiator is 1-Ethyl-3-3 (dimethylaminopropyl) carbodiimide hydrochloride (EDC). Preferably the catalyst is N-hydroxy-succinimide (NHS).

The present invention will be better understood in the light of the following embodiments.

### BRIEF DESCRIPTION OF THE FIGURES

FIG. 1: Kinetic of swelling in terms of wc and wu.

FIG. 2: TGA thermograms for HA and HA-MMPI-bis for thermal stability analysis

FIG. 3: TGA first derivative (DTG) in function of temperature for HA and HA-MMPI-bis, for thermal stability analysis.

FIG. 4: Shear moduli from the frequency sweep test of HA-MMPI-bis

FIG. 5: Shear complex modulus and tan 6 from the frequency sweep test of HA-MMP-bis.

FIG. 6: Shear complex viscosity from the frequency sweep test of HA-MMP-bis.

FIG. 7: Compression moduli and tan 6 from the frequency sweep test of HA-MMP-bis.

### EXPERIMENTAL SECTION

### Example 1—Synthesis of the Inhibitor MMPI-Bis

### Synthesis of Compound 1

See: K. Muguruma et al. ChemMedChem 2021, 16, 1814-1821

### Synthesis of Compound 2

See: B. Richichi et al. Chem. Eur. J. 2016, 22, 1714-1721
V. Baldoneschi et al. ChemPlusChem 2016, 81, 1333-1338
L. Cerofolini et al. Bioorg. Med. Chem. Lett. 2017, 25, 523-527

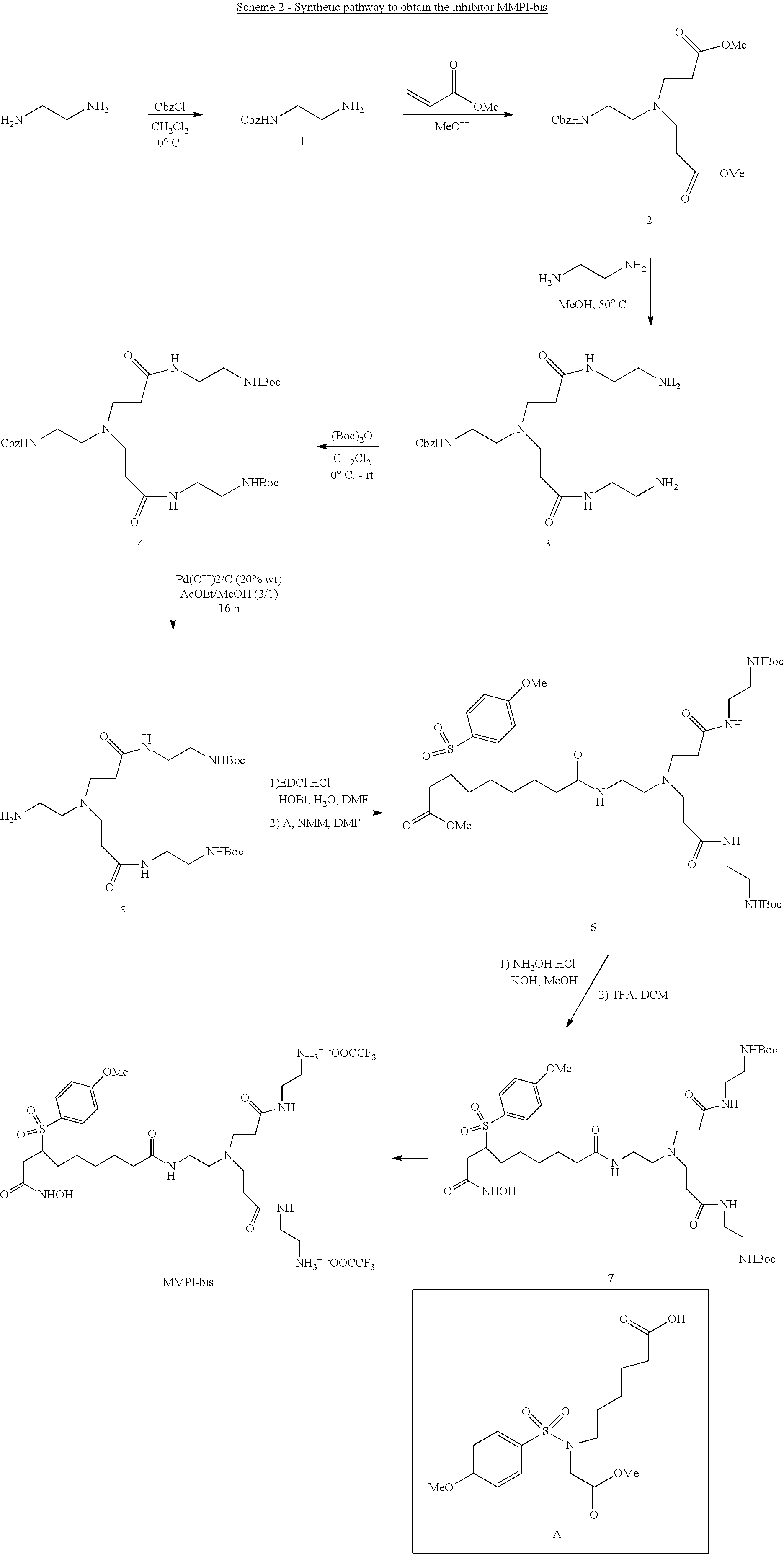

### Synthesis of Compound 3

A solution of 2 (8.0 g, 22 mmol) in MeOH dry (100 mL) was cooled to 0° C. and treated dropwise with ethylenediamine (53.0 g, 885 mmol). The solution obtained was heated to 50° C. and stirred for 16 h. After this time, the organic solvent was removed by co-evaporation with toluene to give 10.3 g of derivative 3, as a pale brown glassy solid which was employed without purification.

ESI-MS m/z (%): 423.58 (100) [M+H]⁺, 445.58 (35) [M+Na]⁺ (calculated for C₂₀H₃₄N₆O₄: 422.53)

¹H NMR: (500 MHz, DMSO-d6) δ 7.85 (t, 2H, 2 NH), 7.37-7.31 (m, 5H, 5 CH), 7.10 (t, 1H, NH), 5.01 (s, 2H, CH₂), 3.03 (m, 6H, 3 CH₂), 2.65 (t, 4H, 2 CH₂), 2.54 (t, 4H, 2 CH₂), 2.45 (t, 2H, CH₂), 2.19 (t, 4H, 2 CH₂).

### Synthesis of Compound 4

A suspension of 3 (10.40 g, 24.50 mmol) in CH₂Cl₂ (120 mL) was cooled to 0° C. and treated with (Boc)₂O (11.70 g, 53.70 mmol). The reaction mixture was stirred at rt for 20 h then diluted with CH₂Cl₂, washed with HCl 1M (3 x) and H₂O (3 x). The organic layer was dried over anhydrous Na₂SO₄. After filtration, the organic solvent was evaporated under vacuum. The crude obtained was purified by flash column chromatography on silica gel (CH₂Cl₂/MeOH 9:1) to give 6.03 g of 4 as a pale-brown oil (40% over two steps).

ESI-MS m/z (%): 623 (45) [M+H]⁺, 645.75 (100) [M+Na]⁺, 661.67 (55) [M+K]⁺ (calculated for C₃₀H₅₀N₆O₈: 622.76)

¹H NMR (500 MHz, DMSO-d6) δ 7.93 (m, 2H, 2 NH CONH), 7.37-7.29 (m, 5H, 5 CH Bn), 7.00 (t, J=5.3 Hz, 1H, NH), 6.77 (t, J=5.2 Hz, 2H, 2 NH), 5.01 (s, 2H, CH₂), 3.06-3.03 (m, 6H, 3 CH₂), 2.98-2.95 (m, 4H, 2 CH₂), 2.64 (t, J=6.8 Hz, 4H, 2 CH₂), 2.44 (t, J=6.8 Hz, 2H, CH₂), 2.18 (t, J=6.8 Hz, 4H, 2 CH₂), 1.37 (s, 18H, 6 CH₃). ¹³C NMR (125 MHz, DMSO-d6) δ 172 (2Cq, C-3), 156.5 (Cq, CO), 156.1 (Cq, CO), 137.7 (Cq), 128.8 (CH), 128.2 (CH), 128.1 (CH), 78.1 (Cq), 65.6 (CH₂), 52.8 (CH₂), 49.9 (2CH₂), 49.1 (2CH₂), 39.1 (CH₂), 39.0 (2CH₂), 33.7 (2CH₂), 28.7 (3CH₃).

### Synthesis of Compound 5

A solution of compound 4 (6.0 g, 10 mmol) in AcOEt/MeOH (3/1), was treated with Pd(OH)₂/C (20% wt, 425 mg, 600 μmol). The mixture was stirred under H₂ atmosphere at rt for 16 h then filtered over a pad of celite; the filtrate was washed with MeOH. The organic layer is evaporated under vacuum to give 4.7 g of derivative 5 as a brown, glassy solid which was used without purification.

ESI-MS m/z (%): 489.58 (100) [M+H]⁺, 511.58 (17) [M+Na]⁺ (calculated for C₂₂H₄₄N₆O₄: 456.93)

¹H NMR: (500 MHz, DMSO-d6) δ 7.94 (t, 2H, 2 NH), 6.80 (t, 2H, 2 NH), 3.05 (dt, 4H, 2 CH₂), 2.96 (dt, 4H, 2 CH₂), 2.63-2.58 (m, 4H, 2 CH₂), 2.38 (t, 2H, CH₂), 2.18 (t, 4H, 2 CH₂), 1.37 (s, 18H, 6 CH₃).

¹³C NMR: (125 MHz, DMSO-d6) δ 172, 156.1, 78.1, 55.7, 50.1, 50.0, 39.0, 33.7, 28.7.

### Synthesis of Compound A

Compound A was synthesized by reacting the sulphonamide of glycine methyl ester with 6-hydroxy benzyl hexanoate as previously reported [E. Attolino et al. Eur. J. Med. Chem. 2010, 45, 5919-5925] Yellow oil (62%). The suphonamide derivative so obtained (3.75 g) was dissolved in THF (80 mL) and H₂O (2.5 mL); Pd/C (10% wt, 521 mg) was added, and the mixture stirred under H2 atmosphere at rt for 16 h. After filtration over a Celite pad, the organic solvent was removed and the crude A obtained (3.56 g, quant.) was used without any other purification.

ESI-MS m/z (%) 372.54 (100) [M−H]⁻ (calculated for: C₁₆H₂₃NO₇S: 373.42)

¹H NMR (500 MHz, DMSO-d6) δ 11.99 (bs, 1H, OH), 7.74 (AA′ part of a AA′MM′ system, J_{AM}=8.6 Hz, 2H, 2 CH), 7.11 (MM′ part of a AA′MM′ system, J_{MA}=8.6 Hz, 2H, 2 CH), 4.20 (s, 2H, CH₂), 3.85 (s, 3H, CH₃), 3.60 (s, 3H, CH₃), 3.09 (t, 2H, CH₂), 2.15 (t, 2H, CH₂), 1.46-1.40 (m, 2H, CH₂), 1.22-1.16 (m, 2H, CH₂).

¹³C NMR (125 MHz, DMSO-d₆) δ 174.8, 170.0, 163.0, 131.3, 130.0, 114.8, 67.5, 56.1, 52.3, 48.7, 48.6, 34.0, 30.9, 27.6, 25.9, 24.5.

### Synthesis of Compound 6

A solution of 5 (3.50 g, 8.00 mmol) in DMF (30 mL), cooled to 0° C., was treated with HOBt-H₂O (1.70 g, 12.90 mmol) and EDAC-HCl (2.50 g, 12.90 mmol). The mixture was cooled to 0° C. and stirred. A second solution was prepared by dissolving compound A (3.0 g, 6.0 mmol) and NMM (2.0 g, 18.0 mmol) in DMF (20 mL) and cooled to 0° C. The two solutions were mixed and stirred at rt for 1 h, then diluted with CH₂Cl₂. The organic layer was washed with NaHCO₃ s.s. (3 x), H₂O (3 x) and brine (1 x) then dried over anhydrous Na₂SO₄. After filtration, the organic solved was removed under vacuum and the crude purified by flash column chromatography on silica gel (CH₂Cl₂/MeOH 9:1) to afford 5.87 g of compound 6, as brownish glassy solid (97% over two steps).

ESI-MS: m/z (%): 844.65 (45) [M+Na]⁺, 866.83 (100) [M+Na]⁺ (calculated for C₃₈H₆₅N₇O₁₂: 844.04)

¹H NMR: (500 MHz, DMSO-d6) δ 7.89 (t, 2H, 2 NH), 7.73 (ad, AA′ part of a AA′MM′ system, J_{AM}=8.9 Hz, 2H, 2CH), 7.6 (t, 1H, NH), 7.10 (ad, MM′ part of a AA′MM′ system, J_{MA}=8.9 Hz, 2H, 2 CH), 6.76 (t, 2H, 2 NH), 4.01 (s, 2H, CH₂), 3.84 (s, 3H, CH₃), 3.6 (s, 3H, CH₃), 3.07 (dt, 8H, 4 CH₂), 2.96 (dd, 4H, 2 CH₂), 2.64 (t, 4H, 2 CH₂), 2.41 (t, 2H, CH₂), 2.18 (t, 4H, 2 CH₂), 2.01 (t, 2H, CH₂), 1.42 (m, 4H, 2 CH₂), 1.37 (s, 18H, 6 CH₃), 1.17 (m, 2H, CH₂).

¹³C NMR: (125 MHz, DMSO-d6) δ 172.3, 172.0, 170.0, 162.9, 156.1, 131.3, 129.6, 114.8, 78.1, 56.1, 52.6, 52.3, 50.0, 48.8, 48.6, 39.1, 37.3, 35.8, 33.7, 28.7, 27.8, 26.1, 25.3.

### Synthesis of Compound 7

A suspension of NH₂OH·HCl (820 mg, 12.0 mmol) in MeOH (5 mL) and a suspension of KOH (985 mg, 18 mmol) in MeOH (2.5 mL) were heated to reflux and the two solutions obtained mixed. The resulting mixture was treated with a solution of 6 (5.00 g, 5.85 mmol) in MeOH (15 mL) and stirred at rt for 30 min. The reaction mixture was treated with HCl (1M, MeOH) until neutralization. After removal of the organic solvent under vacuum, the crude was purified by flash column chromatography on silica gel (CH₂Cl₂/MeOH 9:1) to afford 7 (2.33 g 50%) as a yellow oil.

ESI-MS m/z (%): 845.83 (35) [M+H]⁺, 867.75 (100) [M+Na]⁺, 844.00 (100) [M−H]⁻ (calculated for C₃₇H₄N₈O₁₂S: 845.02).

¹H NMR: (500 MHz, DMSO-d6) δ 10.56 (bs, 1H, OH), 8.91 (bs, 1H, NH), 7.90 (t, 2H, 2 NH), 7.77 (ad, AA′ part of a AA′MM′ system, J_{AM}=8.8 Hz, 2H, 2CH), 7.61 (t, 1H, NH), 7.09 (ad, MM′ part of a AA′MM′ system, J_{MA}=8.8 Hz, 2H, 2 CH), 6.76 (t, 2H, 2 NH), 3.85 (s, 3H, CH₃), 3.65 (s, 2H, CH₂), 3.05 (m, 10H, 5 CH₂), 2.96 (dd, 4H, 2 CH₂), 2.64 (t, 4H, 2 CH₂), 2.41 (t, 2H, CH₂), 2.18 (t, 4H, 2 CH₂), 2.02 (t, 2H, CH₂), 1.42 (m, 4H, 2 CH₂), 1.37 (s, 18H, 6 CH₃), 1.15 (m, 2H, CH₂).

¹³C NMR: (125 MHz, DMSO-d6) δ 172.3, 172.0, 160.0, 156.1, 130, 114.7, 78.1, 57, 56.1, 52.6, 52.3, 51.9, 50.0, 49.1, 48.8, 39.1, 37.3, 35.8, 33.7, 28.7, 27.6, 26.2, 25.3.

### Synthesis of the Bifunctional Inhibitor MMPI-Bis

A solution of 7 (2.0 g, 2.0 mmol) in CH₂Cl₂ (25 mL) was treated with TFA (5.50 g, 47.60 mmol) and stirred at rt for 25 min. The organic solvent was then removed under vacuum to give 3.1 g of MMPI-bis as trifluroacetate salt (yellow oil).

ESI-MS m/z (%): 645.67 (100) [M+H]⁺, 643.92 (100) [M−H]⁻ (calculated for C₃₁H₅₀F₆N₈O₁₂S: 872.84)

¹H NMR (500 MHz, DMSO-d6) δ 10.66 (bs, 1H, OH), 9.52 (bs, 1H, NH-9), 8.39 (t, J=5.4 Hz, 2H, 2 NH), 8.15 (m, 1H, NH), 7.75 (ad, AA′ part of a AA′MM′ system, J_{AM}=8.8 Hz, 2H, 2CH), 7.85 (bs, 4H, 2 NH₂), 7.10 (ad, MM′ part of a AA′MM′ system, J_{MA}=8.8 Hz, 2H, 2 CH), 3.97 (s, 2H, CH₂), 3.85 (s, 3H, CH₃), 3.42-3.37 (m, 6H, 3 CH₂), 3.31 (dt, J=6.4 Hz, 4H, 2 CH₂), 3.16-3.19 (m, 2H, CH₂), 3.04 (t, J=7.3 Hz, 2H, CH₂), 2.88 (dt, J=5.8 Hz, 2H, CH₂), 2.63 (t, J=7.2 Hz, 4H, 2 CH₂), 2.08 (t, J=7.3 Hz, 2H, CH₂), 1.47-1.43 (m, 4H, 2 CH₂), 1.21-1.18 (m, 2H, CH₂).

¹³C NMR (125 MHz, DMSO-d6) δ 174.0 (Cq, CO), 170.4 (Cq, CO), 162.9 (Cq), 158.8 (Cq, CO), 158.6 (Cq, CO), 131.1 (Cq), 129.7 (CH), 114.8 (CH), 56.1 (CH₃), 52.2 (CH₂), 49.6 (CH₂), 49.1 (CH₂), 48.0 (CH₂), 39.0 (CH₂), 37.0 (CH₂), 35.6 (CH₂), 34.2 (CH₂), 29.3 (CH₂), 27.7 (CH₂), 26.2 (CH₂), 25.1 (CH₂).

### Example 2—Preparation of the HA Derivative Chemically Crosslinked with MMPI-Bis

1 g/L of sodium HA (MWᵣᵤ=401 g/mol) salt solution in ultrapure H₂O (UPW) was prepared. The obtained solution was stirred till complete solubilization. Then, EDC, NHS and the MMP-bis solution (10 g/L methanolic solution) were added (from 1:1000 to 1000:1). After addition of crosslinker agent the system was turned to gentle stirring, once the system was homogeneous the stirring was turned off. The molar ratios used in the reaction are reported in the following table 2.

TABLE 2
Molar ratio of the reactant for the synthesis of HA-MMPi-bis.

| Molar ratio | Molar ratio | Molar ratio |
|---|---|---|
| HAᵣᵤ/MMPI-bis | HAᵣᵤ/EDC | HAᵣᵤ/NHS |
| 3:1 | 1:10 | 1:10 |

The reaction was stopped after 2 hours at 25° C. and the obtained crosslinked system was immersed in absolute C₂H₅OH. Once completely shrunk, it was re-swollen with UPW. This process was repeated till no more crosslinker was detected in washing solution. The final product was then freeze-dried.

### Example 3—Physico-Chemical Characterization HA-MMPI-Bis

### Swelling Degree

The swelling kinetics was measured in ultrapure water (UPW). HA-MMPI-bis sample in the dry state was immersed in H₂O and kept at 37° C. The hydrogel was weighted every 30 minutes till constant weight.

The Water Content was calculated by the following equation:

$$wc = ( \frac{{w}_{s} - {w}_{d}}{{w}_{s}} ) \times 100$$

The Water Uptake was calculated by the following equation:

$$w u = ( \frac{{w}_{s} - {w}_{d}}{{w}_{d}} ) \times 100$$

wc, wu, ws and wd are respectively the Water Content, the Water Uptake, the swollen and the dried weight of the hydrogel.

The 3D structure of the hydrogel, its crosslinking degree and the polymer chemistry determine the degree and the kinetic of the swelling. The action of a hydrogel as lubricant or shock-adsorber depends on the swelling capacity of the crosslinked polysaccharide that, in turn, depends on the hydrophilic properties of the material (T. Conrozier, et al. T. Knee, 2016, 23, 842-848).

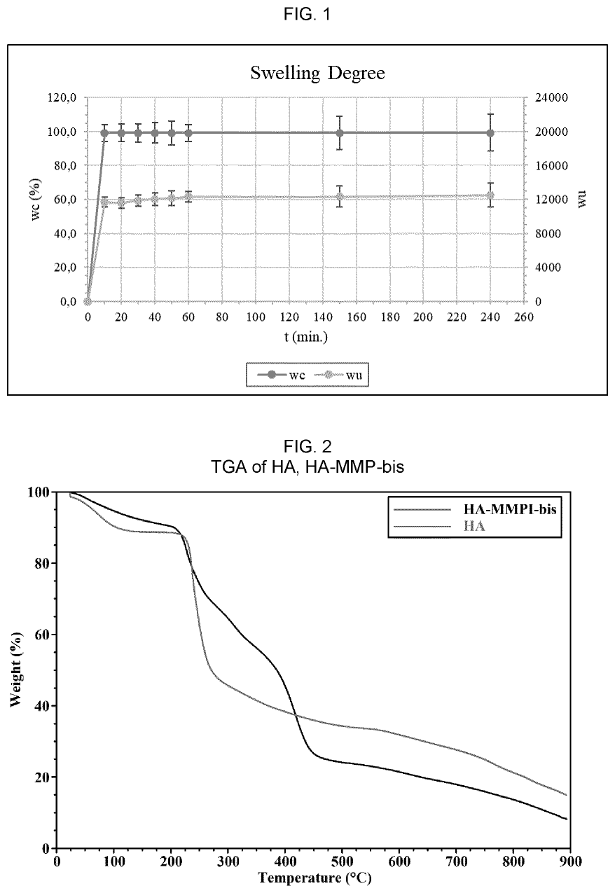

The swelling kinetics are shown in FIG. 1. The hydrogel reaches the swelling equilibrium within 30 minutes with a stable Water Content of 99.2%±0.5%. The Water Uptake follows the same behavior of the Water Content, reaching the equilibrium within half hour with a value of 11,848±652.

### Thermal Stability

### Thermogravimetric Analysis (TGA)

The tests were performed with a SDT-Q600 (TA Instruments), Thermal Advantage Release 5.5.22 was used for instrument control and TA Instruments Universal Analysis 2000 v. 4.5.4. was used for the data analysis.

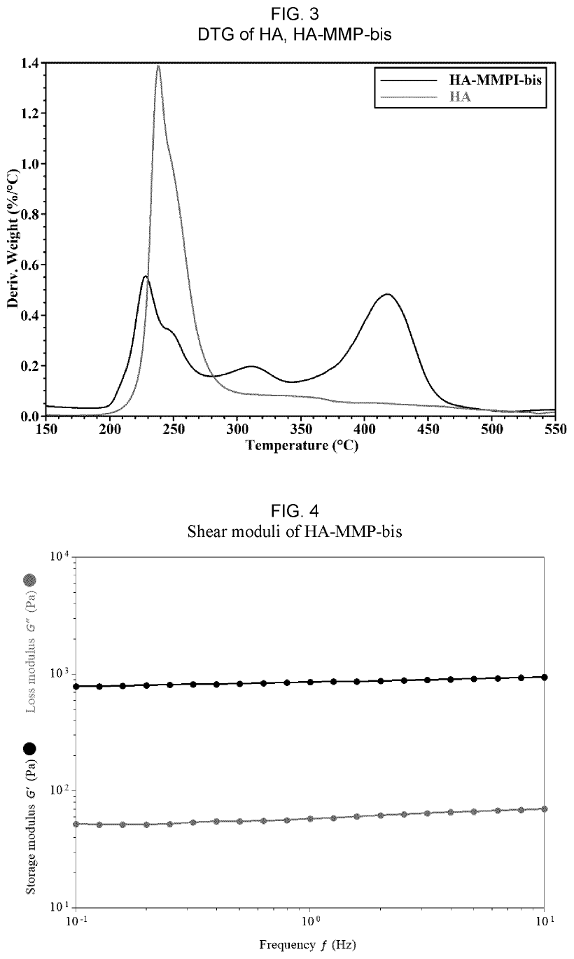

For the thermal stability measurement, samples (about 10 mg at dry state) were put in a Pt crucible and heated from 30° C. to 900° C. under N₂ flow (100 mL/min), with a heating rate of 10° C./min (C. M. Hassan et al. Journal of Applied Polymer Science, 2000, 76, 2075-2079). Thermograms of samples are depicted in FIG. 2 and FIG. 3, and the relative weight losses reported in the following table.

TABLE 3
Results of the thermal stability test

| Sample | 30° C.-200° C. | 200° C.-400° C. | 400° C.-600° C. | R |
|---|---|---|---|---|
| NaHA | 10.0% ± 0.4% | 51% ± 2% | 6.6% ± 0.3% | 0.13 ± 0.01 |
| HA-MMPI-bis | 9.3% ± 0.3% | 45% ± 2% | 24.2% ± 0.8% | 0.54 ± 0.02 |

### Mesopore Size Measurements

### Differential Scanning Calorimetry (DSC)

A DSC Q1000 (TA Instruments Leatherhead, United Kingdom) was used for the determination of mesopore size. Thermal Advantage Release 5.5.22 was used for instrument control and TA Instruments Universal Analysis 2000 v. 4.5.4 for data analysis.

5-10 mg of full swollen HA-MMPI-bis were hermetically sealed in an alodined aluminum hermetic pan and then was performed the following procedure under N₂ flow at 50 mL/min:

Cooling ramp from room temperature to −60° C. with a heating ramp of 5° C./min.

Heating ramp from −60° C. to −0.3° C. with a heating ramp of 5° C./min.

Isotherm at −0.3° C. for 10 min.

Cooling ramp from −0.3° C. to −60° C. with a heating ramp of 0.2° C./min.

The mean radius of the mesopores was calculated by the following equation (M. Iza, et al., “Polym. 2000, 41, 5885-5893):

$$Rp ( nm ) = ( \frac{- 64.67}{Δ T} ) + 0.57$$

Where ΔT is the difference from the temperature of the peak of freezing of H₂O (T=−6.2° C.) in the hydrogel and the triple point of H₂O (Tp=−0.01° C., R. D. Lide, Handbook of Chemistry and Physics, Washington: CRC Press, 2002-2003).

The calculated mean mesopore size for HA-MMPI-bis was 11.0 nm±0.1 nm. This value is reliable with the swelling behavior and high hydrophilicity of the material.

### Types of Water Determination

### TGA—Total Water Content

The tests were performed with an SDT-Q600 (TA Instruments), Thermal Advantage Release 5.5.22 was used for instrument control and TA Instruments Universal Analysis 2000 v. 4.5.4. was used for the data analysis.

For the total H₂O content measurement, 10 mg of full swollen sample was put in a Pt crucible and heated from 30° C. to 300° C. under N₂ flow (100 mL/min), with a heating rate of 10° C./min.

The total water content of HA-MMPI-bis was quantified in the range of 30° C.-200° C. by TGA, and it showed a weight loss of 98%, that corresponds to the total water content of the full swollen hydrogel (G. Leone, et al. Polym. Adv. Technol., 2013, 24, 824-833).

### DSC—Freezable and Non-Freezable Water

The analysis of freezable and non-freezable water was performed by a DSC Q1000 (TA Instruments Leatherhead, United Kingdom). Thermal Advantage Release 5.5.22 was used for instrument control and TA Instruments Universal Analysis 2000 v. 4.5.4 for data analysis.

5-10 mg of full swollen HA-MMPI-bis were put in an alodined aluminum hermetic pan hermetically sealed and then was performed the following procedure under N₂ flow at 50 mL/min:

Cooling ramp from room temperature to −40° C. with a heating ramp of 0.2° C./min.

Isotherm at −40° C. for 5 min.

Heating ramp from −40° C. to 40° C. with a heating ramp of 0.2° C./min.

The freezable H₂O is quantified integrating the endothermic melting peak of the frozen H₂O in the hydrogel sample, and the weight of the freezable water (W_{fH}) in the full swollen hydrogel was calculated by the following equation [16]:

$$\frac{{W}_{f H}}{{W}_{S G}} = \frac{Δ {H}_{m}}{Δ H}$$

Where ΔHₘ is the enthalpy of melting of freezable H₂O (ΔHₘ=269.4 J/g), that is then related to the latent heat of melting of the H₂O (ΔH=324.1 J/g). Not considering the minimal differences in enthalpy of melting of frozen H₂O in different crystalline structures, the ratio ΔHₘ/ΔH corresponds to the weight of freezable H₂O per gram of full swollen hydrogel (W_{SG}).

The weight of the non-freezable H₂O (W_{nfH}) is calculated by the equation:

$${W}_{H} = {W}_{f H} + {W}_{n f H}$$

Where W_{H} is the weight of the total water in the full swollen hydrogel.

Applying the previous two equations, was found that the total content of water in the sample could be subdivided in 83% w/w of freezable water and 17% w/w of non-freezable water. The freezable water is about five times the non-freezable one: this confirms the high hydrophilicity of the system and can explain both the very fast swelling kinetics and high water-uptake of HA-MMPI-bis.

### Mechanical Properties Measurements

### Shear Moduli

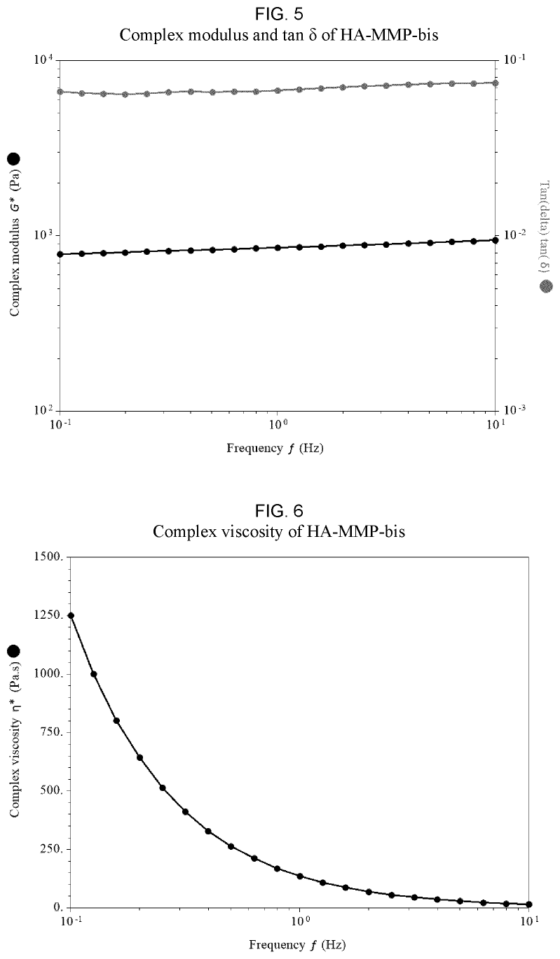

The mechanical properties of HA-MMPI-bis in shear mode were evaluated using a frequency sweep test: HA-MMPI-bis underwent to a frequency ramp from 0.1 Hz to 10 Hz at a constant strain of 1% at 37° C. The results are reported in FIG. 4-6, whereas in the following table the shear mechanical properties of the HA derivative are compared to those of some commercial products.

TABLE 4
Rheological properties for dermal filler application.

| | G′ (Pa) | G″ (Pa) | tan δ | η*(Pa · s) |
|---|---|---|---|---|
| Sample | 0.7 Hz ^{[25]} | | | |
| HA-MMPI-bis | 844 ± 40 | 56 ± 3 | 0.067 ± 0.003 | 191 ± 9 |
| Juvéderm Voluma ® | 270 | 28 | 0.103 | 66.94 |
| Perlane ® | 541 | 86 | 0.158 | 124.95 |
| Restylane Sub-Q ® | 863 | 101 | 0.117 | 198.37 |

### Compression Moduli

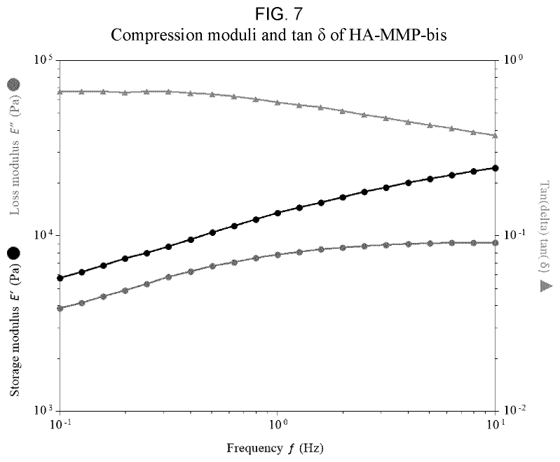

The mechanical properties of HA-MMPI-bis in compression mode were evaluated using a frequency sweep test: HA-MMPI-bis underwent to a frequency ramp from 0.1 Hz to 10 Hz at a constant strain of 1% at 37° C. The results are reported in FIG. 7. The HA-MMPI-bis compression elastic modulus (E′) at 1 Hz is 14.0 kPa±0.6 kPa.

### Mesh Size Determination

The mesh size (ξ) was calculated from the G′ value, using the Rubber Elasticity Theory (RET) (Y. Gan, et al. Biomaterials 2017, 136, 12-28), according to the following equation.

$$ξ = {( \frac{{G}^{′} {N}_{A}}{RT} )}^{- \frac{1}{3}}$$

Where G′ is the elastic modulus in Pa, N_{A} is the Avogadro number, R is the universal gas constant in J·K⁻¹·mol⁻¹, T is the temperature in K

The calculated mesh size for HA-MMPI-bis is 17.1±0.3 nm.

1. A crosslinked hyaluronic acid (HA) derivative of formula (I) 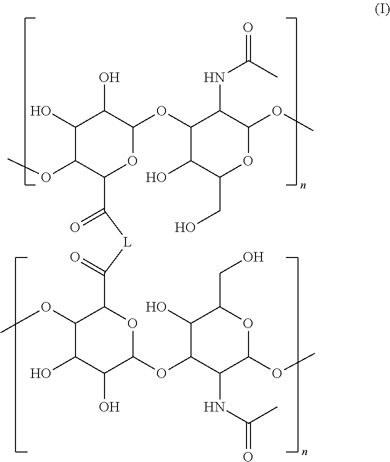
wherein
n is in the range 2.5-25000;
L is a bi- quadri- or octa-valent linker of formula (II) 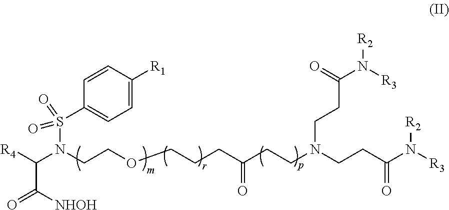
wherein
m is an integer number selected from 0-4;
r is an integer number selected from 1-7;
p is an integer number selected from 1-3;
R₁ is H, OH, OAlk₁₋₄, X, CX₃, Ph, para-C₆H₄—F, OPh, CH₂Ph, wherein X is a halogen;
R₂ is H or R₃;
R₃ is selected in the group consisting of CH₂CH₂NH—, CH₂CH₂(CO)NHCH₂CH₂NH—, CH₂CH₂(CO)N(CH₂CH₂NH—)₂;
R₄ is H, CH₂OH, CH₂SH, CH₂CH₂SMe, CH(CH₃)₂, CH(CH₃)OH.

2. The HA derivative according to claim 1 having a degree of functionalization between 0.1% and 100% of the active site of the repeating unit of HA(HAᵣᵤ).

3. The HA derivative according to claim 1 wherein m=0, r=2, p=1.

4. The HA derivative according to claim 1 wherein R1 is OMe.

5. The HA derivative according to claim 1 wherein R₂ is H and R₃ is CH₂CH₂NH—.

6. The HA derivative according to claim 1 wherein R₄ is H, CH₂OH.

7. The HA derivative according to claim 1 wherein linker L is MMPi-bis of formula (II-bis):

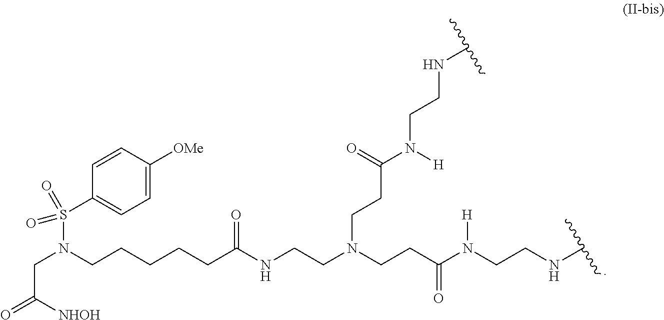

8. A method for the treatment of a disease comprising administering to a subject in need thereof an effective amount of the HA derivative according to claim 1.

9. A method for the treatment of an inflammatory processes involved in osteoarticular diseases comprising administering to a subject in need thereof an effective amount of the HA derivative according to claim 1.

10. A cosmetic method comprising administering to a subject in need thereof the HA derivative according to claim 1.

11. A pharmaceutical or cosmetic formulation, comprising the HA derivative according to claim 1 and at least another pharmaceutical or cosmetic suitable component or active specie/s.

12. A process for preparing the HA derivative of formula (I) according to claim 1 wherein HA is contacted with a compound of formula (IIa) 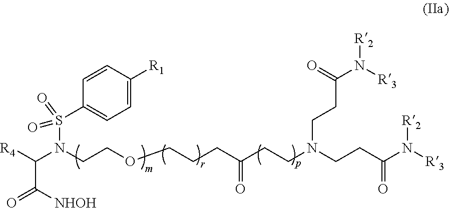
wherein m, r, p R₁ and R₄ are as described above;
R′₂ is H or R′₃;
R′₃ is selected in the group consisting of CH₂CH₂NH₂, CH₂CH₂(CO)NHCH₂CH₂NH₂, CH₂CH₂(CO)N(CH₂CH₂NH₂)₂.

13. The process according to claim 12 wherein the HA has a molecular weight from 0.1 MDa to 3 MDa.

14. The process according to claim 12 wherein HA is contacted with a compound of formula (IIa) in 100:1-1:1 molar ratio, preferably 3:1 molar ratio.

15. The process according to claim 12 including the presence of an initiator and/or a catalyst, preferably the initiator is 1-Ethyl-3-3 (dimethylaminopropyl) carbodiimide hydrochloride (EDC), preferably the catalyst is N-hydroxy-succinimide (NHS).
